(19) United States
(12) Patent Application Publication
(10) Pub. No.: US 2005/0240423 A1
(43) Pub. Date: Oct. 27, 2005

(54) Preparing for and handling of in-flight medical emergencies

(76) Inventors: Harald Becker, Fluh (CH); Edgar Buhrle, Freiburg (DE)

Correspondence Address: NEIFELD IP LAW, PC, 4813-B EISENHOWER AVENUE, ALEXANDRIA, VA, 22304, US

(21) Appl. No.: 10/832,364

(22) Filed: Apr. 27, 2004

(51) Int. Cl. G06F 17/60

(52) U.S. Cl. 705/1; 705/3

(57) ABSTRACT

In a method for providing medical assistance in the event of an in-flight medical emergency during a passenger flight, training is provided to medical practitioners in the handling of in-flight medical emergencies; an identification scheme is established that allows medical practitioners who completed the training to be identified; it is determined, by means of the identification scheme, if a medical practitioner who completed the training is present as a passenger of the passenger flight; and the medical practitioner is asked to provide the medical assistance. The invention improves the medical treatment of emergency patients during a flight and avoids legal uncertainties, which presently arise when a passenger who steps forward in an in-flight medical emergency is allowed to treat a patient.

### FIELD OF THE INVENTION

The present invention concerns the field of medical training and the field of during a flight.

### BACKGROUND OF THE INVENTION

Statistics show that approximately 0.01% of all airplane passengers fall ill during a flight. While this proportion may seem to be small, it translates to about 14,000 is medical incidents each year worldwide. It may further be estimated that about 400 deaths will occur on board each year, and a considerable number of diversions must be made in the event of serious emergencies. Furthermore, the estimated number of unreported cases is high.

Several measures are presently implemented at least by some airlines to cope with in-flight medical emergencies. Flight attendants are sent to intensive first-aid training courses and attend annual refresher courses. Furthermore, so-called AEDs, semi-automatic defibrillators, are available on board of every airplane, and all crew members are trained in their use. A hotline to a medical advice center is available to provide ground support to crew members or a doctor who may be on board. Some airlines also carry comprehensive medical equipment, which may comprise a first-aid kit, a doctor's kit and an oxygen supply apparatus, on board of their airplanes.

In the event of an in-flight medical emergency, it is common practice that the captain or another crew member makes an announcement asking that a doctor, who may be on board as a passenger, identifies himself or herself. On average, this announcement will be successful in approximately 65-70% of all cases. This rather high rate can be explained by the fact that doctors tend to be among the frequent flyers. According to a survey, 65% of all doctors have experienced a medical emergency on board of an airplane at least once in their lives.

It is the policy of some airlines that anyone who steps forward in response to a request for a doctor is allowed to treat a patient on board without any further checks regarding the purported doctor's identity or qualification. Of course, this approach entails the problem that impostors who only pass themselves off as doctors may be allowed to treat patients, thus creating possible liability risks for the respective airline. Other airlines require an unambiguous identification of a person as a doctor before this person is allowed to treat any patients on board. This approach carries the risk that genuine doctors may be prevented from treating patients in the event of a medical emergency for the sole reason that no suitable identification is at hand. Again, serious liability issues may arise for the airlines. There exists a need for reducing these liability risks by providing an easy, quick and comprehensive means for unambiguously identifying qualified doctors during a flight.

The occurrence of a medical emergency poses difficult problems for the entire crew. As detailed above, it will often be difficult for flight attendants to assess the qualification of a person purporting to be a doctor who may happen to be on board while, at the same time, fulfilling their duty to immediately help the passenger. Furthermore, pilots, who have no detailed medical knowledge, are expected to decide whether or not a diversion is necessary. Because of their uncertainty, many pilots will err on the side of caution. As a consequence, some of the diversions (each of which costing about US-$100,000.00 on average) are superfluous. Even if a hotline to a medical advice center exists, its usefulness is limited because of the difficulties in remotely assessing the medical situation. A need exists to reduce this number of unnecessary diversions.

The situation is also difficult for the doctor who may be on board when a medial emergency occurs. In most cases, the doctor will not have specific knowledge in the field of air-travel related medical emergencies. The doctor is also unlikely to have sufficient insight into the physiological situation that exists in airplanes at flight altitudes. Furthermore, the doctor will usually not know about the medical skills of the cabin crew and the medical equipment that is available onboard. There exists a need for improving the training of medical practitioners to remedy the above shortcomings. Furthermore, it would be desirable to provide incentives for the medical practitioners to attend training courses that specifically concern in-flight medical emergencies.

Since many doctors are aware of the above shortcomings, they may decide not to reveal their profession if the services of a doctor are requested during a flight. Not providing medical assistance in the case of an emergency is, however, at least contrary to the code of conduct provided by medical ethics. In some jurisdictions, e.g., under German and Australian law, doctors may even face criminal prosecution if they do not help in a medical emergency. On the other hand, doctors who provide help face the risk of malpractice suits, especially if it turns out that the doctors were ill prepared for their actions. Therefore a need exists to make doctors aware of the legal situation and to incite them to offer help during a flight, if required.

Further legal problems arise with respect to the compensation of doctors who provided their services in a medical emergency. While airlines, as a rule, offer substantial rewards for the services of the doctors, it is an open legal question whether the airline is actually obliged to pay any medical fees. Several lawsuits have been initiated by doctors in an attempt to win considerable amounts from airlines for the medical services the doctors had performed. There is a need for providing a binding legal framework that defines the mutual rights and obligations of the doctors and the airlines.

US 2003/0057323 A1 discloses an aircraft medical unit that includes equipment to enable the passengers or crew within the aircraft to make real-time contact with doctors, hospitals or other health providers who are able to provide relevant guidance and information to assist in the treatment process.

CA 2,317,781 A1 discloses a device for medical emergencies on board of an aircraft that makes it possible to administer emergency first aid if there is no trained medical personnel on board of the aircraft.

### OBJECTS AND SUMMARY OF THE INVENTION

It is therefore an object of the present invention to improve the medical treatment of emergency patients during a flight. It is a further object of the invention to avoid legal uncertainties of all kinds, which presently arise when a passenger who steps forward in an in-flight medical emergency is allowed to treat a patient. In particular, such legal uncertainties may involve liability issues for both the airline and the doctor as well as the amount of compensation that is due for any medical services rendered. Yet a further object of the present invention is to meet at least some of the needs stated above.

The present invention comprises a method for providing medical assistance in the event of an in-flight medical emergency during a passenger flight, wherein an identification scheme is used, said identification scheme allowing the identification of medical practitioners who completed a training in the handling of in-flight medical emergencies, the method comprising the steps of determining, by means of said identification scheme, if a medical practitioner who completed said training is present as a passenger of said passenger flight, and asking said medical practitioner to provide said medical assistance.

The present invention further comprises a method for preparing for the event of an in-flight medical emergency during a passenger flight, the method comprising the steps of providing training to medical practitioners in the handling of in-flight medical emergencies, and establishing an identification scheme that allows medical practitioners who completed said training to be identified, thereby enabling airline personnel to determine, by means of said identification scheme, if a medical practitioner who completed said training is present as a passenger of said passenger flight such that said medical practitioner may be asked to provide said medical assistance.

Yet further, the present invention comprises an identification card and a database, respectively, that allow medical practitioners who completed a training in the handling of in-flight medical emergencies to be identified, thereby enabling airline personnel to determine, by means of said identification card or database, if a medical practitioner who completed said training is present as a passenger of said passenger flight such that said medical practitioner may be asked to provide medical assistance in response to the occurrence of an in-flight medical emergency during a passenger flight.

All in all, the present invention yields significantly higher standards of flight safety and of quality of medical treatment in the case of emergencies. This may give an airline that takes part in the program of the present invention (and possibly also sponsors training courses at least to some extent) a significant advantage over its competitors. Passengers in general will prefer a particular airline if they feel that this airline provides improved service in the case of a medical emergency. Doctors who have completed the training will also prefer this airline because the training experience creates strong ties between the doctors and the airline and because the doctors feel more at ease on board if they know the medical equipment that is available in the case of an in-flight emergency.

The training also raises the willingness of doctors to assist in the case of an emergency since the doctors feel better prepared and are aware both of the medical equipment available on board and of the capabilities of the flight attendants. This will not only be beneficial for the emergency patient, but it will also create a general sense of security that will minimize the unrest among the other passengers. If a larger percentage of all doctors is willing to help in the case of an emergency, the number of flights where no doctor at all steps forward to help in response to a public announcement is minimized. In fact, in many flights there will be several doctors capable and willing to provide qualified assistance, and the cabin crew will be in a position to select the most suitable doctor for any particular incident. Such a selection is facilitated in some embodiments of the invention wherein the identification scheme provides information with respect to the skills of the respective doctors.

The present invention also avoids legal liabilities for the participating airlines since the identification scheme allows flight attendants to identify suitable doctors quickly and with certainty. By providing good training, the present invention further reduces the risks for a doctor to become the defendant in a malpractice suit. The legal situation between the airline and the participating doctors may be further clarified; in some embodiments of the invention, by a pre-negotiated legal framework regulating the respective rights and duties that exist between the doctor and the airline, and/or the liability of the doctor in the event of malpractice, and/or the compensation, if any, which the doctor will receive for his or her services.

According to some embodiments of the present invention, the identification scheme may comprise identification cards and/or a database. The identification of a passenger as a qualified doctor may be made, in some embodiments, at the time of reservation and/or check-in and/or boarding and/or before take-off, and, in other embodiments, in response to the occurrence of an in-flight medical emergency.

In some embodiments of the present invention, the training may provide doctors with specific routines for treating medical problems that most frequently occur on board of an aircraft. At least one training session may take place in a (simulated or real) aircraft environment.

The medical training according to the present invention is preferably open for the majority or all members of the medical profession. This means that the medical training is preferably not intended just for a small proportion of doctors (e.g., restricted to doctors that are employed by airlines or other companies as professional medical flight attendants). To the contrary, it is desirable that as many doctors of all medical fields, languages and qualifications as possible attend the training since this increases the likelihood that at least one qualified doctor will happen to be on board of any regular flight. Therefore the medical training is preferably intended to be useful for all doctors, including doctors who would otherwise hardly step forward in a medical emergency (e.g., psychiatrists, eye specialists, . . . ).

The basic idea of the present invention is to increase the likelihood that a qualified doctor will be present by chance as an “ordinary passenger” whenever a medical emergency occurs, and that such a doctor can be identified quickly and correctly. Thus, in preferred embodiments of the invention, the identification scheme is not restricted to doctors that are present in the aircraft because they have been hired specifically to provide pre-planned medical assistance during the aircraft transportation of a patient. Instead, the identification scheme should cover as many doctors of all medical fields, languages and qualifications as possible.

### DETAILED DESCRIPTION OF THE INVENTION

Further features, objects and advantages of the present invention will be apparent from the following detailed description of sample embodiments. Reference is made to the schematic drawings, in which:

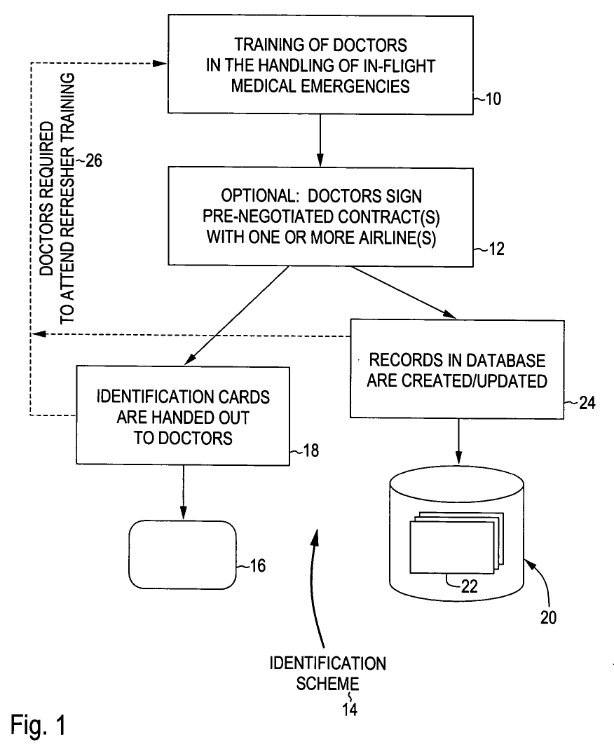

FIG. 1 shows steps that are performed in connection with the training of doctors for in-flight medical emergencies,

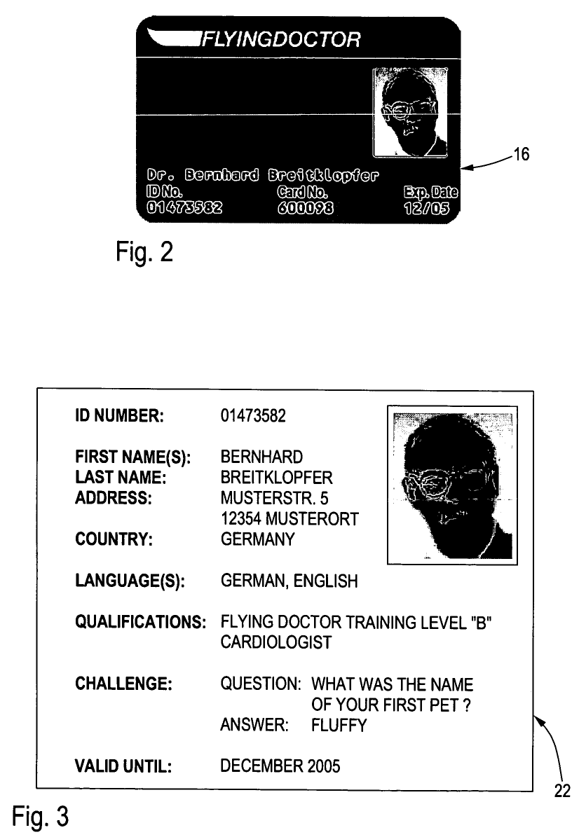

FIG. 2 shows an example of an identification card,

FIG. 3 shows an example of a database entry,

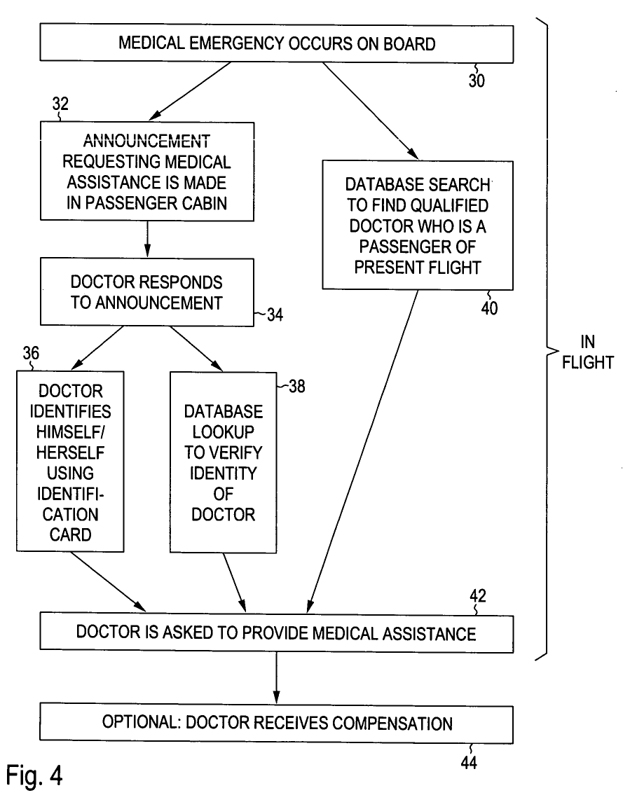

FIG. 4 shows steps that are performed in response to an in-flight medical emergency according to some embodiments of the present invention, and

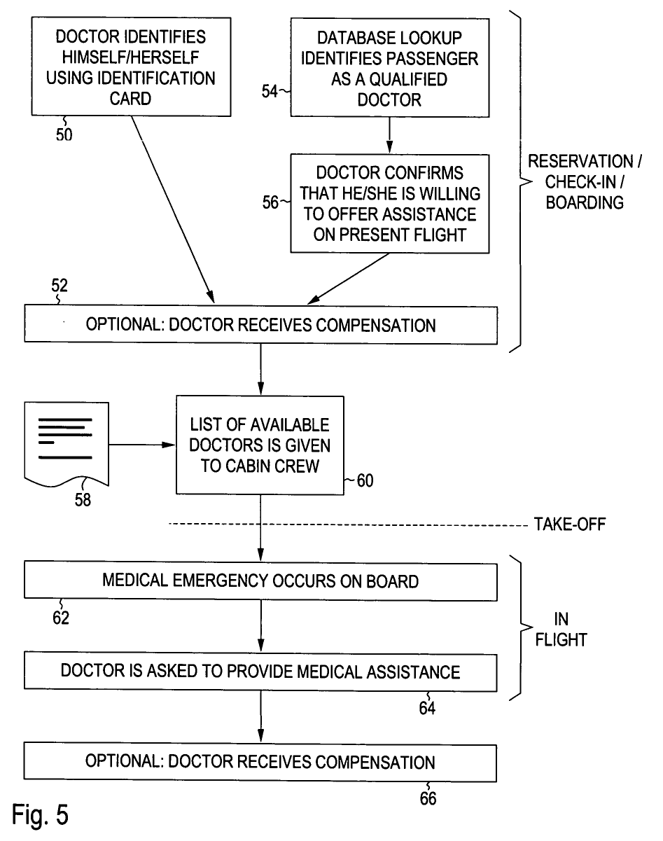

FIG. 5 shows steps that are performed during preparation of a flight and in response to an in-flight medical emergency according to some embodiments of the present invention.

As the first step 10 shown in FIG. 1, a specialized company holds training sessions in which interested doctors acquire comprehensive knowledge and skills in the fields of emergency and travel related medicine. In particular, the doctors are trained in the handling of medical emergencies on board of passenger airplanes. The training comprises a review of generally approved techniques for the in-flight handling of medical emergencies, a familiarization with the medical equipment that is available on board, and a communication training. The communication training teaches skills known from CRM (Crew Resource Management) that improve communication between the doctor, the crew members and other passengers during critical situations. The teaching comprises a theoretical part as well as a practical part in which typical cases are simulated, together with cabin crew members, in a cabin simulator or an aircraft simulator or on board of an aircraft. Any questions are answered in a debriefing, and written material with guidelines for the treatment of often occurring cases are handed out.

A typical two-day training program may, for example, include the following topics:
Aircraft-related topics:
   Physiological situation during a flight, including discussion of typical risks for patients, discussion of cabin environment, air pressure and oxygen levels during a flight, . . .
   Medical equipment available on board and its application
   Emergency landing and emergency exit from an airplane, including treatment of injured passengers after the exit
   On-board organization
   Teamwork between doctor and cabin crew
   . . .
Medical topics:
   Basics of reanimation
   Artificial respiration, ventilation and thorax compression, in particular use of specially developed techniques tailored to the restricted space available in airplanes
   Respiration problems, including asthma, objects blocking the respiration tract, hyperventilation, . . .
   Cardiological problems
   Neurological problems
   Circulatory disorders
   Hypoglycemia
   Case simulation of the most frequent medical disorders on board
   . . .
Communication topics:
   Communication techniques and communication tools for emergency situations
   Role of the doctor in stress management
   . . .

Besides the basic training detailed above there may be specialized courses for particular problems and brush-up courses for renewing the doctors' knowledge and skills.

The training may also comprise information about the legal situation of doctors facing an in-flight medical emergency, including information that may be specific to the practice of one or more airlines. In an optional step 12, the doctors may be asked to sign pre-negotiated contracts with one or more airlines, the contracts stipulating the mutual rights and obligations in the case of medical in-flight emergencies. In particular, such contracts may define the circumstances under which the doctor is required to provide medical assistance or allowed to refuse providing such assistance, questions of liability for the doctor and/or the airline, and possibly rules relating to a compensation that may be payable to the doctor. In alternative embodiments, no actual contracts are signed, but the doctors are made familiar with the terms and conditions that would be offered by the individual airlines.

The company that holds the training courses or another entity further provides an identification scheme 14 for allowing quick and unambiguous identification of flight passengers who are doctors and who have successfully completed the required training. In some embodiments, the identification scheme 14 comprises that identification cards 16 are handed out in step 18 to the doctors who have completed the training. Instead or in addition to an identification by the identification cards 16, the identification scheme 14 may comprise a database 20 that stores a record 22 for each doctor who has successfully completed the training. This record 22 is created or updated in step 24 upon completion of the training.

In some embodiments, the registration of a doctor in the identification scheme 14 will be valid indefinitely. However, it is preferable to require that all registered doctors attend periodic refresher trainings 26 in order to maintain their status in the identification scheme 14. For example, the identification cards 16 or the records 22 in the database 20 may comprise a validity date and may need to be renewed every two years.

The costs for attending the basic and refresher trainings as well as for participating in the identification scheme 14 may be borne by the doctors and/or by the airlines and/or by sponsors like, e.g., the pharmaceutical industry. All of theses parties have an interest in establishing and maintaining a training program and identification scheme 14, as outlined above.

FIG. 2 shows an example of an identification card 16 that may be handed out to a doctor in step 18. The identification card 16 may be similar in size and appearance to a credit card, and it may show the name and the picture of the card holder, various identification and security numbers, and a validity date. The holder of the identification card 16 may quickly identify himself or herself as a qualified medical practitioner on board of an airplane in the event of an in-flight medical emergency, and the picture of the authorized card holder on the identification card 16 makes it difficult for an impostor to pass himself of herself off as a qualified doctor even if the identification card 16 has been lost or stolen. In some embodiments, the identification card 16 may also be used as a credit card or as a card identifying its holder for a bonus miles program.

FIG. 3 shows an example of a record 22 that may be contained in the registered doctors database 20. The record 22 may comprise the name, address and picture of the registered doctor, a validity date and information about the medical and language skills of the doctor. Different training and skill levels of the doctor and different specializations for particular types of medical problems may be distinguished. It is to be understood that such additional information may also be given on the identification cards 16 in some embodiments of the present invention.

The record 22 may further comprise an entry that allows a quick and unambiguous check regarding the identity of any person who purports to be the doctor named in the record 22. This entry may be a secret password which the doctor is expected to know or, as shown in the example of FIG. 3, a challenge question together with the expected response.

FIG. 4 exemplifies typical sequences of steps that may take place on board of an aircraft during a flight. The triggering event is the occurrence of a medical emergency on board in step 30. According to some embodiments of the invention, the flight attendants will then make an announcement in the passenger cabin asking if a qualified doctor is present and requesting his or her assistance (step 32). In many cases, a passenger will respond to this announcement (step 34).

According to the present invention, it will now be verified whether the responding passenger is actually a qualified doctor who has completed the required training. Such a verification may, e.g., comprise step 36 in which the doctor presents his or her identification card 16.

If the doctor does not have his or her identification card 16 readily available, or if the identification scheme 14 does not provide for identification cards 16 at all, a database lookup may be performed in step 38 to verify whether or not the person who responded to the announcement is recorded as a qualified doctor in the database 22. Depending on the policy of the respective airline, it may be considered sufficient if the name given by the person who responded to the announcement is contained in a record 22 of the database 20, or an additional identification verifying this name may be required (e.g., a passport or some other picture ID card), or the person may be asked for his or her password or for the response to the challenge question stored in the record 22. The database lookup 38 may be performed by suitable equipment on board of the airplane, if such equipment is available, or a ground station may carry out the database lookup of step 38 in response to a request which the pilot of the aircraft radios to the ground station.

As an alternative to making a public announcement in step 32, a database search may be performed in step 40 to find a qualified doctor who is a passenger of the present flight. Technically, such a database search may be implemented by automatically comparing the passenger list of the present flight with the names contained in the qualified doctors database 20. It may then be possible to directly approach a qualified doctor if his or her seat number is known, or to make an announcement asking specifically for the passenger with the name determined in the database search. This approach may be preferable to making a general public announcement because it creates less unrest among the other passengers. If desired, further checks may be made (similar to the checks detailed above in connection with steps 36 and 38) in order to verify that the person who claims to be the passenger found in step 40 is not an impostor.

After a qualified doctor has been found according to one of the ways detailed above, he or she is asked to provide the needed medical assistance (step 42). If several doctors happen to be passengers of a particular flight, the most suitable doctor may be selected on the basis of his or her language and/or medical skills, which are apparent from the record 22 or, in some embodiments, are stated on the identification card 16.

Because of the comprehensive training the doctor has received, he or she will be able to deal with the medical emergency in a highly qualified manner. This includes providing optimum treatment for the patient, making good use of the available technical and medical equipment, assisting the pilot in his decision of whether or not a diversion will be necessary, working well with the cabin crew as a team, and avoiding any unnecessary unrest among the other passengers.

In an optional step 44, which usually takes place well after the flight, the doctor receives the pre-negotiated compensation for his or her services in the form of a flat fee or according to a pre-negotiated fee schedule.

According to the embodiments shown in FIG. 4, the steps of identifying a qualified doctor are only performed in-flight in response to the occurrence of a medical emergency. This approach has the advantage that none of these steps will be necessary at all for most flights. On the other hand, time is often of essence in the case of medical emergencies. It may therefore be preferable to identify any qualified doctors that are passengers of a particular flight before take-off, i.e., during the reservation or check-in or boarding phases. Such embodiments of the present invention are exemplified in FIG. 5.

According to a first embodiment, the doctor identifies himself or herself during reservation or check-in or boarding by means of his or her identification card 16 (step 50). This process is similar to showing a mileage program card, and in some embodiments the identification card 16 also contains the membership information of the card holder for a bonus miles program. By showing the identification card 16, the doctor also signifies that he or she is willing to offer his or her medical assistance during the flight, if required. Optionally, the doctor may receive some small compensation for this willingness; see step 52. This compensation may, for example, comprise some additional bonus miles or preferred seating or preferred check-in or a class upgrade or additional luggage allowance or lounge usage.

As an alternative to step 50, a database lookup may be performed in step 54 in which a person reserving a flight or checking in or boarding a flight is identified as a registered doctor. If a matching record 22 in the database 20 is found, the doctor may be asked in step 54 whether or not he or she is willing to offer medical assistance, if required. Furthermore, an additional check as to the identity of the respective person may be made in some embodiments. For example, the appearance of the person may be compared to the picture contained in the database record 22, or the person may be asked for the password or for the answer to the challenge question. Again, an optional compensation is possible in step 52.

When the above steps have been completed, a list 58 of the doctors that are present on a particular flight is given to the cabin crew in preparation for take-off; see step 60. The list 58 may also comprise information regarding the seat numbers of the respective doctors and their particular skills.

If a medical emergency occurs in flight (step 62), the cabin crew may consult the list 58 and immediately approach a registered doctor (preferably the most qualified one with respect to the particular emergency). Again, it is possible to require an additional check as to the identity of the person who occupies the seat number given in the list 58. The doctor identified in this way will then be asked to provide medical assistance in step 64. Optionally, a further compensation may be paid to the doctor in step 66 for his or her actual services, in addition to any compensation that has been incurred in step 52. Steps 64 and 66 correspond to steps 42 and 44 as shown in FIG. 4, and reference is made to the more detailed description of these steps above.

The present invention therefore provides a way of preparing medical practitioners for handling in-flight medical emergencies, and the invention provides a way for the actual handling of such emergencies whereby the medical treatment of emergency patients during a flight is improved and legal uncertainties are avoided for all parties. It should be emphasized that the teachings of the present invention are not intended to apply to specialized medical professionals that are employed by an airline or by another service firm to provide medical assistance during the pre-planned airplane transportation of patients. Instead, the present invention is intended to apply to medical professionals who are “ordinary” aircraft passengers, and who may some day be confronted with an unforeseen medical emergency during a flight which they happen to attend.

The particulars contained in the above description of sample embodiments should not be construed as limitations of the scope of the invention, but rather as exemplifications of preferred embodiments thereof. Accordingly, the scope of the invention should be determined not by the embodiments illustrated, but by the appended claims and their legal equivalents.

1. A method for providing medical assistance in the event of an in flight medical emergency during a passenger flight, wherein an identification scheme is used, said identification scheme allowing the identification of medical practitioners who completed a training in the handling of in flight medical emergencies, the method comprising the steps of:
determining, by means of said identification scheme, if a medical practitioner who completed said training is present as a passenger of said passenger flight, and
asking said medical practitioner to provide said medical assistance.

2. The method of claim 1, wherein said identification scheme comprises identification cards that signify that the respective card holder is a medical practitioner who completed said training.

3. The method of claim 1, wherein said identification scheme comprises at least one database of medical practitioners who completed said training.

4. The method of claim 1, wherein said step of determining if a medical practitioner who completed said training is present as a passenger of said passenger flight is performed prior to the occurrence of any in flight medical emergency.

5. The method of claim 1, wherein said step of determining if a medical practitioner who completed said training is present as a passenger of said passenger flight is performed in response to the occurrence of said in-flight medical emergency.

6. The method of claim 1, wherein said identification scheme provides further information with respect to the skills of the respective medical practitioners who completed said training.

7. The method of claim 1, wherein said training in the handling of in flight medical emergencies comprises at least one training session that is held in an aircraft environment.

8. The method of claim 1, wherein said training in the handling of in flight medical emergencies is intended for at least the majority of all members of the medical profession.

9. The method of claim 1, wherein a legal framework has been pre negotiated, the legal framework regulating at least one of the following:
the respective rights and duties that exist between the medical practitioner and the airline operating the flight,
the liability of the medical practitioner in the event of malpractice, and
the compensation, if any, which the medical practitioner will receive for his or her services.

10. The method of claim 1, wherein said medical practitioner is a passenger of said passenger flight for a purpose that is different from the purpose of providing pre-planned medical assistance during the aircraft transportation of a patient.

11. A method for preparing for the event of an in flight medical emergency during a passenger flight, the method comprising the steps of:
providing training to medical practitioners in the handling of in flight medical emergencies, and
establishing an identification scheme that allows medical practitioners who completed said training to be identified, thereby enabling airline personnel to determine, by means of said identification scheme, if a medical practitioner who completed said training is present as a passenger of said passenger flight such that said medical practitioner may be asked to provide said medical assistance.

12. The method of claim 11, wherein said identification scheme comprises identification cards that signify that the respective card holder is a medical practitioner who completed said training.

13. The method of claim 11, wherein said identification scheme comprises at least one database of medical practitioners who completed said training.

14. The method of claim 11, wherein said step of determining if a medical practitioner who completed said training is present as a passenger of said passenger flight is performed prior to the occurrence of any in flight medical emergency.

15. The method of claim 11, wherein said step of determining if a medical practitioner who completed said training is present as a passenger of said passenger flight is performed in response to the occurrence of said in-flight medical emergency.

16. The method of claim 11, wherein said identification scheme provides further information with respect to the skills of the respective medical practitioners who completed said training.

17. The method of claim 11, wherein said training in the handling of in flight medical emergencies comprises at least one training session that is held in an aircraft environment.

18. The method of claim 11, wherein said training in the handling of in flight medical emergencies is intended for at least the majority of all members of the medical profession.

19. The method of claim 11, wherein a legal framework has been pre negotiated, the legal framework regulating at least one of the following:
the respective rights and duties that exist between the medical practitioner and the airline operating the flight,
the liability of the medical practitioner in the event of malpractice, and
the compensation which the medical practitioner will receive for his or her services.

20. The method of claim 11, wherein said medical practitioner is a passenger of said passenger flight for a purpose that is different from the purpose of providing pre-planned medical assistance during the aircraft transportation of a patient.

21. A method for providing medical assistance in the event of an in flight medical emergency during a passenger flight, the method comprising the steps of:
providing training to medical practitioners in the handling of in flight medical emergencies,
establishing an identification scheme that allows medical practitioners who completed said training to be identified,
determining, by means of said identification scheme, if a medical practitioner who completed said training is present as a passenger of said passenger flight, and
asking said medical practitioner to provide said medical assistance.

22. An identification card that allows medical practitioners who completed a training in tho handling of in flight medical emergencies to be identified, thereby enabling airline personnel to determine, by means of said identification card, if a medical practitioner who completed said training is present as a passenger of said passenger flight such that said medical practitioner may be asked to provide medical assistance in response to the occurrence of an in flight medical emergency during a passenger flight.

23. A database that allows medical practitioners who completed a training in the handling of in flight medical emergencies to be identified, thereby enabling airline personnel to determine, by means of said database, if a medical practitioner who completed said training is present as a passenger of said passenger flight such that said medical practitioner may be asked to provide medical assistance in response to the occurrence of an in flight medical emergency during a passenger flight.

24. A method for providing medical assistance in the event of an in flight medical emergency during a passenger flight, the method comprising:
making a training completion determination, said training completion determination indicating whether a specified medical practitioner completed training on how to respond to in flight medical emergencies;
if said training completion determining indicates that said specified medical practitioner completed said training, then storing in a database an identifier uniquely identifying said specified medical practitioner;
identifying the existence of an in flight medical emergency on a passenger flight;
making a presence determination, said presence determination indicating whether a passenger present on said passenger flight is associated with said identifier uniquely identifying said medical practitioner; and
if said presence determination indicates that said passenger present on said passenger flight is associated with said identifier, then asking that passenger for assistance relating to said medical emergency.

25. The method of claim 24 further comprising:
generating an identification card storing said identifier; and
providing said identification card to said medical practitioner.

26. The method of claim 24 wherein said database stores identifiers of a plurality of medical practitioners who have completed said training.

27. The method of claim 26 wherein said presence determination comprises determining whether identifiers exist in said database for any passengers on said passenger flight.

28. The method of claim 27 further comprises transmitting identity information from said database to said passenger flight.

29. The method of claim 28 further comprising transmitting, in association with said identity information, information specifying medical skills of a corresponding medical practitioner.

30. The method of claim 24 further comprising storing in said database at least one of the following:
the respective rights and duties that exist between said specified medical practitioner and an airline operating said passenger flight;
liability of said specified medical practitioner in the event of malpractice relating to in flight medical care provided by said specified medical practitioner; and
compensation, if any, which said specified medical practitioner is entitled relating to providing medical service or agreeing to provide medical service on one or more passenger flights.

31. The method of claim 24 further comprising transacting a fare for said passenger for passage on said passenger flight.

32. The method of claim 24 generally implemented using a computer system.

33. A computer system for providing medical assistance in the event of an in flight medical emergency during a passenger flight, the system comprising:
means for making a training completion determination, said training completion determination indicating whether a specified medical practitioner completed training on how to respond to in flight medical emergencies;
means for, if said training completion determining indicates that said specified medical practitioner completed said training, then storing in a database an identifier uniquely identifying said specified medical practitioner;
means for identifying the existence of an in flight medical emergency on a passenger flight;
means for making a presence determination, said presence determination indicating whether a passenger present on said passenger flight is associated with said identifier uniquely identifying said medical practitioner; and
means for, if said presence determination indicates that said passenger present on said passenger flight is associated with said identifier, then providing a human intelligible instruction to ask that passenger for assistance relating to said medical emergency.
